(19) United States
(12) Patent Application Publication
(10) Pub. No.: US 2008/0072716 A1
(43) Pub. Date: Mar. 27, 2008

(54) Tool structure

(76) Inventor: Jin Fu Chen, Dali City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/524,463

(22) Filed: Sep. 21, 2006

(51) Int. Cl. B25B 7/02

(52) U.S. Cl. 81/423; 81/415

(57) ABSTRACT

A tool structure composed of two pivotally connected handles and a tool head. The handle pivot shaft of the handles is spaced from the head pivot shaft of the tool head by a certain distance to form a double-lever structure for saving strength. A pin member is fitted through each handle in parallel to the handle pivot shaft, whereby the pin members can be forced to axially move within the handles. Each pin member has a large diameter section and a small diameter section. When replacing the tool head, a user only needs to press the pin members of the handles with a hand. At this time, the large diameter sections of the pin members are detached from the insertion notches of the tool head to easily replace the tool head with another tool head with different usage. The replacement can be completed without using any tool. Therefore, the tool head can be quickly assembled with the handles.

### BACKGROUND OF THE INVENTION

The present invention is related to a tool structure, and more particularly to a tool structure in which the tool head can be easily replaced with another tool head with different usage.

FIG. 9 shows a conventional tool having two handles 8. When the handles 8 are fully opened, the short sections 811 of the fixing pins 81 of the handles 8 can be aligned with the openings 91 of the tool head 9. At this time, the insertion sections 93 of the tool head 9 can be inserted into the handles 8 with the fixing pins 81 inserted in the insertion notches 92 of the tool head 9. Then the handles 9 are closed. The handles 8 are spaced from the pivot shaft 94 of the tool head 9 by a certain distance, whereby the fixing pins 81 can be rotated within the insertion notches 92 of the tool head 9. The long sections 812 of the fixing pins 81 prevent the tool head 9 from detaching from the handles 8. Therefore, the handles 8 and the tool head 9 can be firmly assembled. When replacing the tool head with another tool head with different usage, the handles 8 are fully opened to align the short sections 811 of the fixing pins 81 of the handles 8 with the openings 91 of the tool head 9. Then the tool head 9 can be easily detached from the handles 8 and the other tool head can be inserted into the handles 8.

The above structure has a shortcoming that only when the handles 8 are fully opened and the tool head 9 is fully opened, the short sections 811 of the fixing pins 81 of the handles 8 can be accurately aligned with the openings 91 of the tool head 9 for taking out and replacing the tool head 9. It is dangerous to replace the tool head 9. This is because the fully opened tool head 9 tends to drop down to hurt somebody.

### SUMMARY OF THE INVENTION

It is therefore a primary object of the present invention to provide an improved tool structure in which the handle pivot shaft is spaced from the head pivot shaft by a certain distance. Also, the pin members of the handles are pivotally fitted in the insertion notches of the tool head so as to form a double-lever structure for saving strength. Furthermore, when replacing the tool head, a user only needs to press the pin members of the handles with a hand to easily replace the tool head with another tool head with different usage, such as a scissors, a pincers, etc. The replacement can be completed without using any tool. Therefore, the tool head can be quickly assembled with the handles.

It is a further object of the present invention to provide the above tool structure in which a switch plate is disposed on the pin members of the handles. When a user presses the press face of the middle section of the switch plate, the two pin members are simultaneously pressed down to conveniently replace the tool head.

It is still a further object of the present invention to provide the above tool structure in which the switch plate is disposed on the protruding ends of the pin members. Two stopper members are screwed on the protruding ends of the pin members. One of the stopper members is formed with a receptacle having a stopper section. The chucked section of the switch plate is chucked in the stopper member, whereby the switch plate prevents the handles from being freely opened. When not used, the two handles will not be unexpectedly opened to cause danger.

It is still a further object of the present invention to provide the above tool structure in which each insertion section of the tool head has ahead locating point, whereby when replacing the tool head, the tool head can be truly closed and located.

It is still a further object of the present invention to provide the above tool structure in which each handle has a handle locating point near the handle pivot shaft, whereby when replacing the tool head, the handles can be truly closed and located in a position for easily replacing the tool head.

It is still a further object of the present invention to provide the above tool structure in which the small diameter section of the pin member is a flattened cylinder. Only when the tool head and the handles are closed, the tool head can be assembled with the handles. That is, the tool head and the handles must be fixed at a specific angle for the assembly. This ensures the safety in replacement of the tool head.

It is still a further object of the present invention to provide the above tool structure in which both the large diameter section and small diameter section of the pin member are cylindrical. The replacement of the tool head can be performed in any closing angle. This is quite convenient to the user.

According to the above objects, the tool structure of the present invention includes:

two handles pivotally connected with each other via a handle pivot shaft, a pin member being fitted through each handle in parallel to the handle pivot shaft, whereby the pin members can be forced to axially move within the handles, each pin member having a large diameter section and a small diameter section, the large diameter section having a diameter larger than the diameter of the small diameter section, the small diameter section being fitted through the handle to protrude from the handle, a stopper member being fixed with the protruding end of the small diameter section protruding from the handle; and

a tool head composed of two clamping members, the clamping members being pivotally connected with each other via a head pivot shaft, the handle pivot shaft being spaced from the head pivot shaft by a certain distance, each clamping member having an insertion section formed with an insertion notch, the insertion notch having an opening with a width smaller than the inner diameter of the insertion notch and the diameter of the large diameter section of the pin member, the width of the opening being larger than the diameter of the small diameter section of the pin member, whereby in normal state, the large diameter sections of the pin members are pivotally disposed in the insertion notches of the insertion sections.

The present invention can be best understood through the following description and accompanying drawings wherein:

### BRIEF DESCRIPTION OF THE DRAWINGS

FIG. 1 is a perspective exploded view of a first embodiment of the present invention;

FIG. 2 is a front view of the first embodiment of the present invention;

FIG. 3 shows the relationship between the positions of the insertion sections of the tool head and the pin members of the handles of the first embodiment of the present invention when replacing the tool head;

FIG. 4 is a sectional view of the first embodiment of the present invention;

FIG. 5 shows the replacement of the tool head of the first embodiment of the present invention;

FIG. 6 is a sectional view of a second embodiment of the present invention;

FIG. 7 is a sectional view according to FIG. 6, showing the replacement of the tool head of the second embodiment of the present invention;

FIG. 8 is a perspective exploded view of a third embodiment of the present invention; and

FIG. 9 shows that the handles of a conventional tool are fully opened for taking out the tool head.

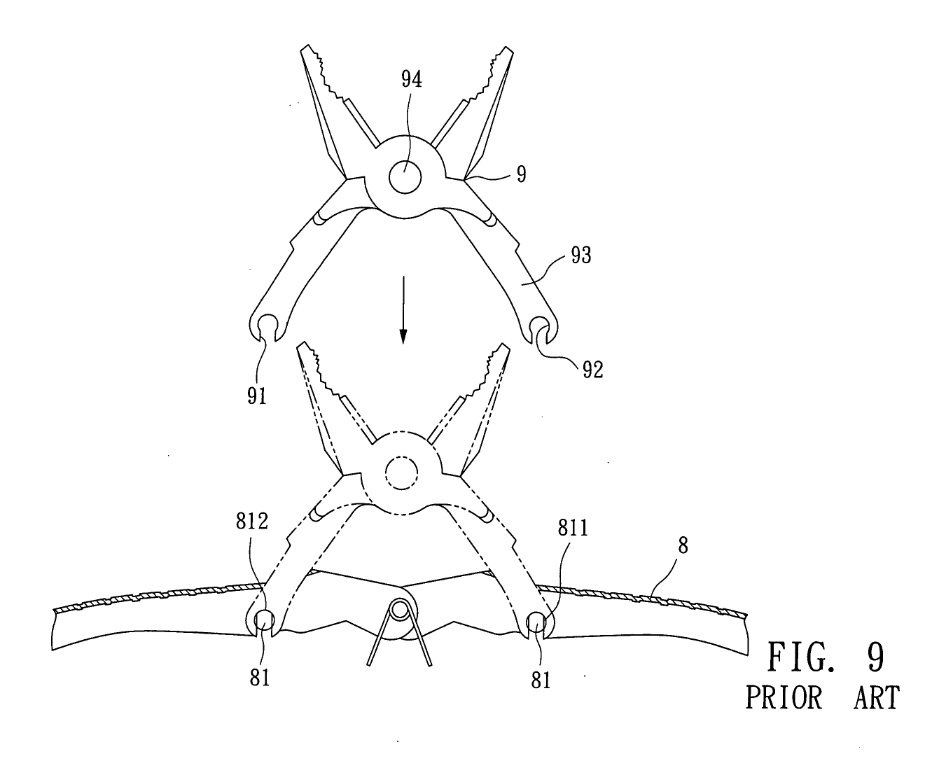

### DETAILED DESCRIPTION OF THE PREFERRED EMBODIMENTS

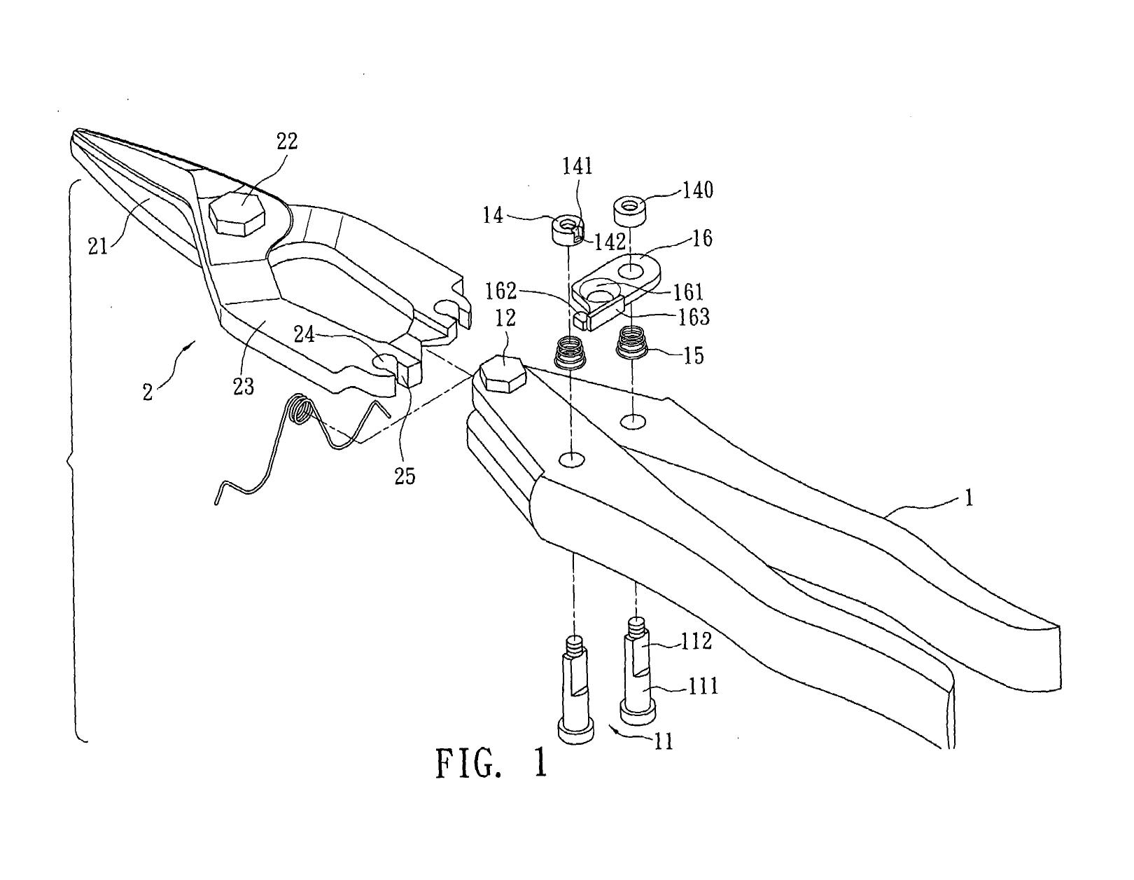

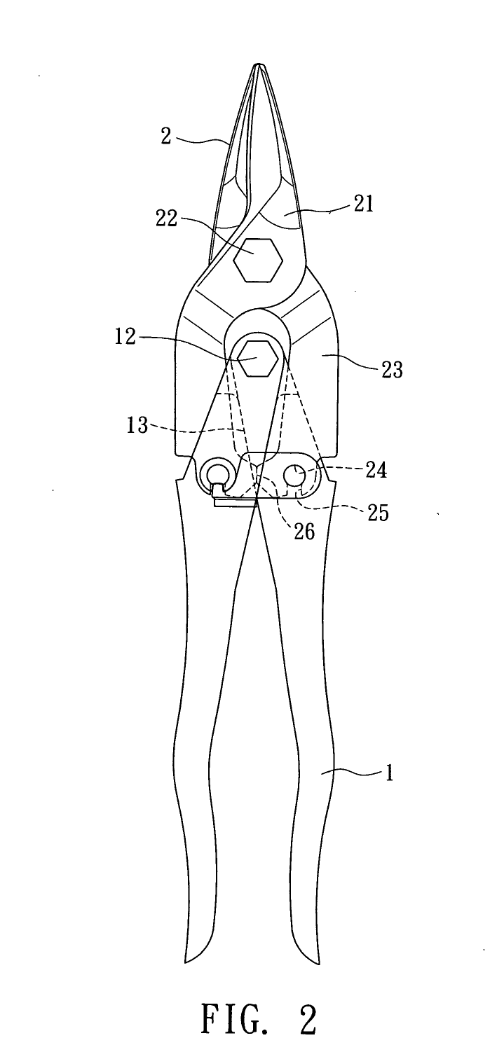

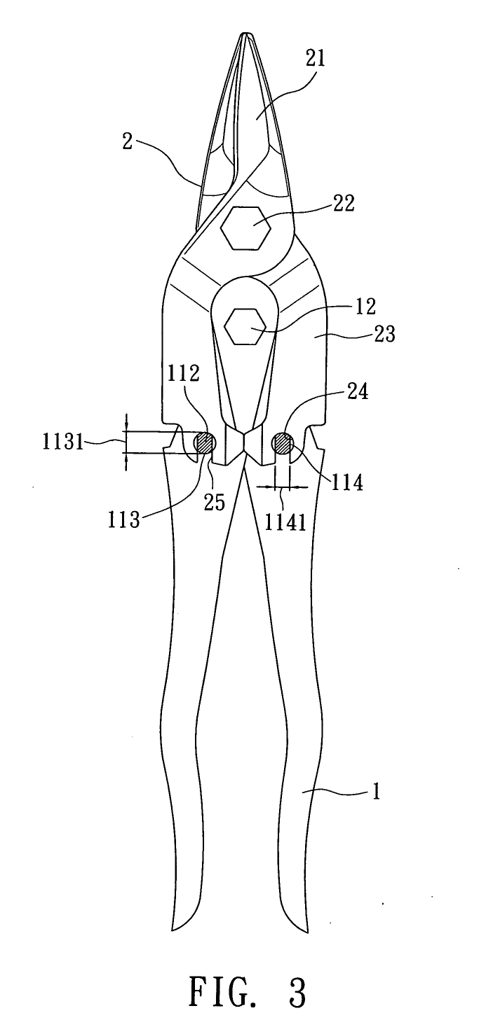

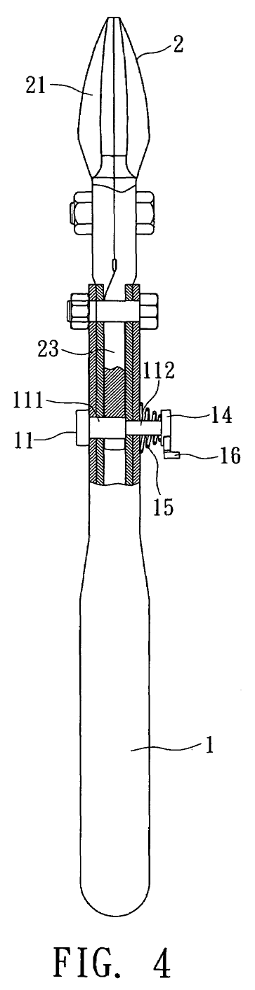

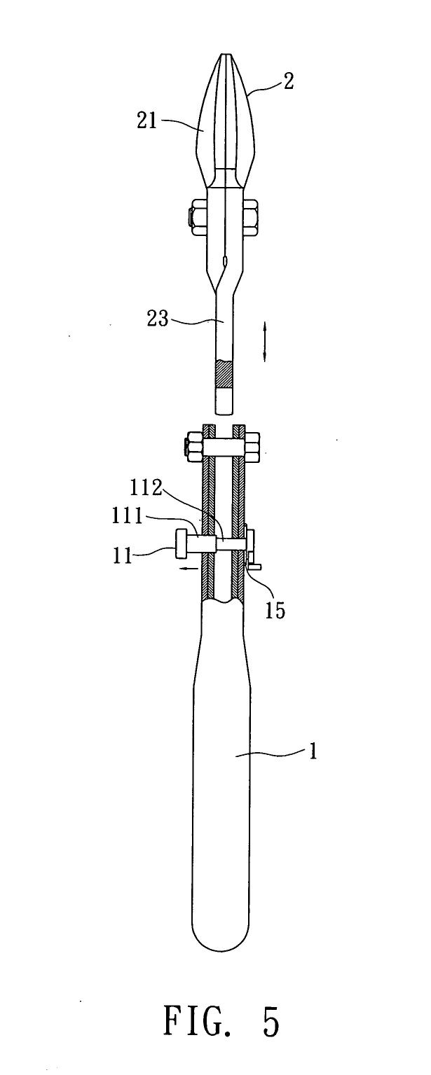

Please refer to FIGS. 1 to 5. The tool structure of the present invention includes two handles 1 pivotally connected with each other via a handle pivot shaft 12. A pin member 11 is fitted through each handle 1 in parallel to the handle pivot shaft 12. The pin members 11 can be forced to axially move within the handles 1. Each pin member 11 has a large diameter section 111 and a small diameter section 112. The large diameter section 111 has a diameter larger than the diameter of the small diameter section 112. The small diameter section 112 is fitted through the handle 1 to protrude from the handle 1. A stopper member 14, 140 is fixed with the protruding end of the small diameter section 112 protruding from the handle 1. In this embodiment, the large diameter section 111 of the pin member 11 is cylindrical, while the cross-section of the small diameter section 112 of the pin member 11 has two long sections 113 and two short sections 114. The distance between the long sections 113 is defined as a first length 1131, while the distance between the two short sections 114 is defined as a second length 1141. The first length 1131 is longer than the second length 1141.

The tool structure of the present invention further includes a tool head 2 composed of two clamping members 21. The clamping members 21 are pivotally connected with each other via a head pivot shaft 22. The handle pivot shaft 12 is spaced from the head pivot shaft 22 by a certain distance. Each clamping member 21 has an insertion section 23 formed with an insertion notch 24. The insertion notch 24 has an opening 25 with a width smaller than the inner diameter of the insertion notch 24 and the diameter of the large diameter section 111 of the pin member 11. The width of the opening 25 is larger than the diameter of the small diameter section 112 of the pin member 11. Accordingly, in normal state, the large diameter sections 111 of the pin members 11 can be pivotally disposed in the insertion notches 24 of the insertion sections 23. In addition, the width of the opening 25 is smaller than the first length 1131 and larger than the second length 1141.

Each handle 1 has a handle locating point 13 near the handle pivot shaft 12, whereby the handles 1 can be truly closed and located. The insertion section 23 of the clamping member 21 also has a head locating point 26, whereby the tool head 2 can be truly closed and located.

The stopper member 14 is screwed on the protruding end of the small diameter section 112 of the pin member 11. A spring 15 is disposed between the stopper member 14 and the handle 1. Two ends of the spring 15 respectively abut against the stopper member 14 and the handle 1. After the pin member 11 is pressed, the spring 15 can restore the pin member 11 to its home position where the large diameter section 111 is positioned in the handle 1.

In this embodiment, a switch plate 16 is disposed on the protruding ends of the small diameter sections 112 of the pin members 11. A middle section of the switch plate 16 is formed with a press face 161 between the two pin members 11. One stopper member 14 of the stopper members is formed with a receptacle 141 having a stopper section 142. The switch plate 16 has a chucked section 162 corresponding to the receptacle 141 of the stopper member 14. In addition, the switch plate 16 has a driving section 163 adjacent to the chucked section 162.

According to the above arrangement, when replacing the tool head 2 with another tool head with different usage, the handles 1 and the tool head 2 can be closed to complete the replacement. Via the driving section 163, a user can push the switch plate 16 to a true position where the chucked section 162 of the switch plate 16 is placed in the receptacle 141 of the stopper member 14. When the user presses down the press face 161 of the switch plate 16, the chucked section 162 of the switch plate 16 is stopped by the stopper section 142 of the receptacle 141. At the same time, the two pin members 11 are driven to axially move to make the large diameter sections 111 of the pin members 11 move out of the handles 1. Also, the short sections 114 of the small diameter sections 112 of the pin members 11 are aligned with the openings 25 of the tool head 2. At this time, the tool head 2 can be detached from the handles 1. The insertion sections 23 of another tool head 2 can be inserted into the handles 1 and the small diameter sections 112 of the pin members 11 are inserted into the insertion notches 24 of the tool head 2. Then, the pin members 11 are released to make the large diameter sections 111 of the pin members 11 inserted into the insertion notches 24 of the tool head 2. At this time, the replacement is completed.

According to the above arrangement, the present invention has the following advantages:
1. The handle pivot shaft is spaced from the head pivot shaft by a certain distance. Also, the pin members of the handles are pivotally fitted in the insertion notches of the tool head so as to form a double-lever structure for saving strength. Furthermore, when replacing the tool head, a user only needs to press the pin members of the handles with a hand to easily replace the tool head with another tool head with different usage, such as a scissors, a pincers, etc. The replacement can be completed without using any tool. Therefore, the tool head can be quickly assembled with the handles.
2. The switch plate is disposed on the pin members of the handles. When a user presses the press face of the middle section of the switch plate, the two pin members are simultaneously pressed down to conveniently replace the tool head.
3. One of the stopper members is formed with a receptacle having a stopper section. The chucked section of the switch plate is chucked in the stopper member, whereby the switch plate prevents the handles from being freely opened. When not used, the two handles will not be unexpectedly opened to cause danger.
4. Each insertion section of the tool head has a head locating point, whereby when replacing the tool head, the tool head can be truly closed and located.
5. Each handle has a handle locating point near the handle pivot shaft, whereby when replacing the tool head, the handles can be truly closed and located in a position for easily replacing the tool head.
6. The small diameter section of the pin member is a flattened cylinder. Only when the tool head and the handles are closed, the tool head can be assembled with the handles. That is, the tool head and the handles must be fixed at a specific angle for the assembly. This ensures the safety in replacement of the tool head.

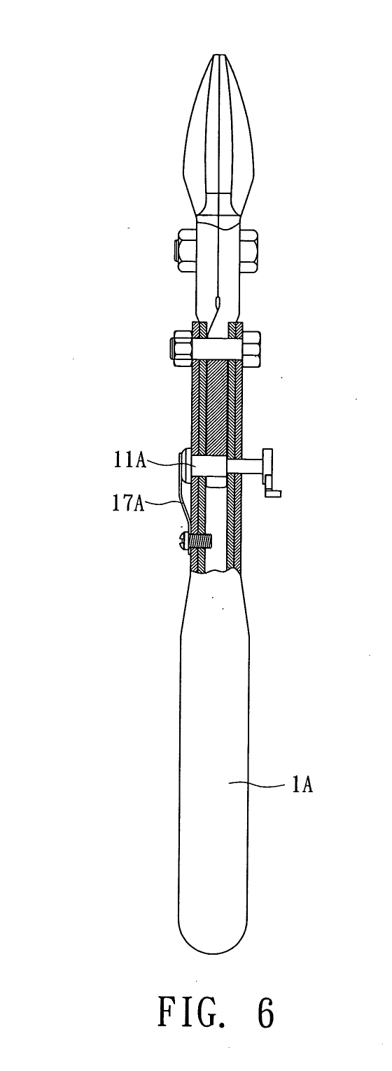

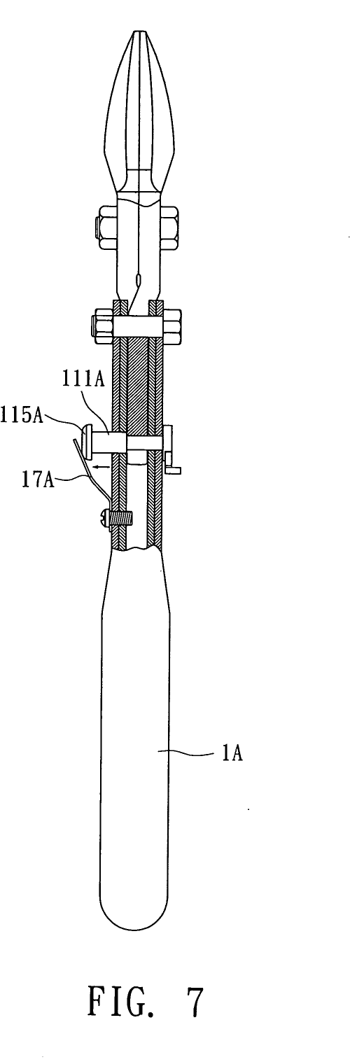

FIGS. 6 and 7 show a second embodiment of the present invention, which is different from the first embodiment in that each handle 1A has a leaf spring 17A. The pin member 11A has a head end section 115A adjacent to the large diameter section 111A. The leaf spring 17A abuts against the head end section 115A, whereby after pressed, the large diameter section 111A of the pin member 11A can be restored to its home position in the handle 1A. This embodiment can achieve the same effect as the first embodiment.

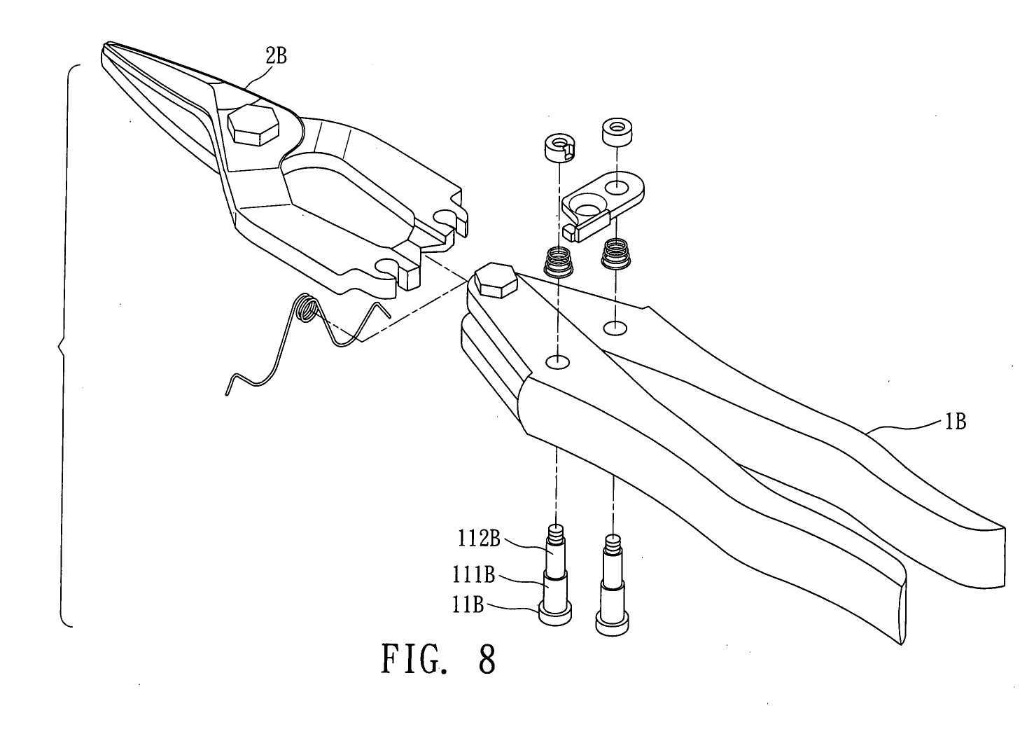

FIG. 8 shows a third embodiment of the present invention, which is different from the first embodiment in that both the large diameter section 111B and small diameter section 112B of the pin member 11B are cylindrical. When replacing the tool head 2B, it is unnecessary to open or close the handles 1B and the tool head 2B to a specific angle. That is, the replacement can be performed without closing the tool head 2B and, the handles 1B. A user only needs to press the pin members 11B of the handles 1B to replace the tool head 2B. This is quite convenient to the user. This embodiment can also achieve the same effect as the first embodiment.

The above embodiments are only used to illustrate the present invention, not intended to limit the scope thereof. Many modifications of the above embodiments can be made without departing from the spirit of the present invention.

What is claimed is:

1. A tool structure comprising:
two handles pivotally connected with each other via a handle pivot shaft, a pin member being fitted through each handle in parallel to the handle pivot shaft, whereby the pin members can be forced to axially move within the handles, each pin member having a large diameter section and a small diameter section, the large diameter section having a diameter larger than the diameter of the small diameter section, the small diameter section being fitted through the handle to protrude from the handle, a stopper member being fixed with the protruding end of the small diameter section protruding from the handle; and
a tool head composed of two clamping members, the clamping members being pivotally connected with each other via a head pivot shaft, the handle pivot shaft being spaced from the head pivot shaft by a certain distance, each clamping member having an insertion section formed with an insertion notch, the insertion notch having an opening with a width smaller than the inner diameter of the insertion notch and the diameter of the large diameter section of the pin member, the width of the opening being larger than the diameter of the small diameter section of the pin member, whereby in normal state, the large diameter sections of the pin members are pivotally disposed in the insertion notches of the insertion sections.

2. The tool structure as claimed in claim 1, wherein the large diameter section of the pin member is cylindrical, while the cross-section of the small diameter section of the pin member has two long sections and two short sections, a distance between the long sections being defined as a first length, while the distance between the two short sections being defined as a second length, the first length being longer than the second length, the width of the opening of the insertion section being smaller than the first length and larger than the second length.

3. The tool structure as claimed in claim 1, wherein both the large diameter section and small diameter section of the pin member are cylindrical.

4. The tool structure as claimed in claim 1, wherein the insertion section of the clamping member has a head locating point, whereby the tool head can be truly closed and located.

5. The tool structure as claimed in claim 1, wherein each handle has a handle locating point near the handle pivot shaft, whereby the handles can be truly closed and located.

6. The tool structure as claimed in claim 1, wherein the stopper member is screwed on the protruding end of the small diameter section of the pin member, a spring being disposed between the stopper member and the handle, two ends of the spring respectively abutting against the stopper member and the handle, whereby after the pin member is pressed, the spring can restore the pin member to its home position where the large diameter section is positioned in the handle.

7. The tool structure as claimed in claim 1, wherein each handle has a leaf spring, the pin member having a head end section adjacent to the large diameter section, the leaf spring abutting against the head end section, whereby after pressed, the large diameter section of the pin member can be restored to its home position in the handle.

8. The tool structure as claimed in claim 1, wherein a switch plate is disposed on the protruding ends of the small diameter sections of the pin members, a middle section of the switch plate being formed with a press face between the two pin members.

9. The tool structure as claimed in claim 8, wherein one of the stopper members is formed with a receptacle having a stopper section, the switch plate having a chucked section corresponding to the receptacle of the stopper member, the switch plate further having a driving section adjacent to the chucked section.
